(19) United States
(12) Patent Application Publication
(10) Pub. No.: US 2025/0216221 A1
(43) Pub. Date: Jul. 3, 2025

(54) LVDT interface device

(71) Applicant: Vladimir Dergachev, Herndon, VA (US)

(72) Inventor: Vladimir Dergachev, Herndon, VA (US)

(21) Appl. No.: 18/400,240

(22) Filed: Dec. 29, 2023

(51) Int. Cl. G01D 5/22

(52) U.S. Cl. CPC G01D 5/2291

(57) ABSTRACT

To reduce the cost of making LVDT measurements we disclose a way to make an interface device that allows to perform LVDT measurements with a smart phone, a tablet, or other computing device capable of measuring analog electric signals. The device can also be used to make measurements with other sensors such as flux gate sensors.

### CROSS-REFERENCE TO RELATED APPLICATIONS

63/478,071—LVDT interface device and method

### BACKGROUND OF THE INVENTION

LVDT—linear variable differential transformers are widely used devices for distance measurement. They are particularly useful for precision measurement of small distances. A typical setup includes one or more LVDT sensors and an apparatus to perform the reading. The apparatus to read out the LVDT often consists of an amplifier and/or LVDT “signal conditioner” and a display or communications unit to report the measurement. Sometimes the amplifier or signal conditioner are combined with the display unit into one device.

A typical LVDT consists of two identical excitation coils (L1 and L2) and one readout coil (L3) as shown on FIG. 1. There might also be an optional core F. For measurement, either the core F is moved relative to the coils, or the position of the coil L3 changes with respect to other coils.

A sinusoidal signal is applied to P1 and P2 which creates opposing magnetic fields in L1 and L2. If the optional ferromagnetic core and coil L3 are symmetric with respect to coils L1 and L2 there is no output signal, besides noise, on P3 and P4 because the influences of L1 and L2 cancel.

As the position of ferromagnetic core and/or L3 is shifted relative and L1 and L2 coils, the terminals P3 and P4 develop an output signal proportional to the amount of shift.

A conventional LVDT measurement will supply a stable excitation signal to P1 and P2, and then measure and display the output signal generated on P3 and P4.

### BRIEF SUMMARY OF THE INVENTION

To reduce the cost of making LVDT measurements we disclose a way to make an interface device that allows to perform LVDT measurements with a smart phone, a tablet, or other computing device capable of measuring analog electric signals. For example, it could be a microcontroller with a sound input.

### BRIEF DESCRIPTION OF THE SEVERAL VIEWS OF THE DRAWING

FIG. 1. Schematic of typical LVDT

FIG. 2. Example of LVDT adapter schematic

### DETAILED DESCRIPTION OF THE INVENTION

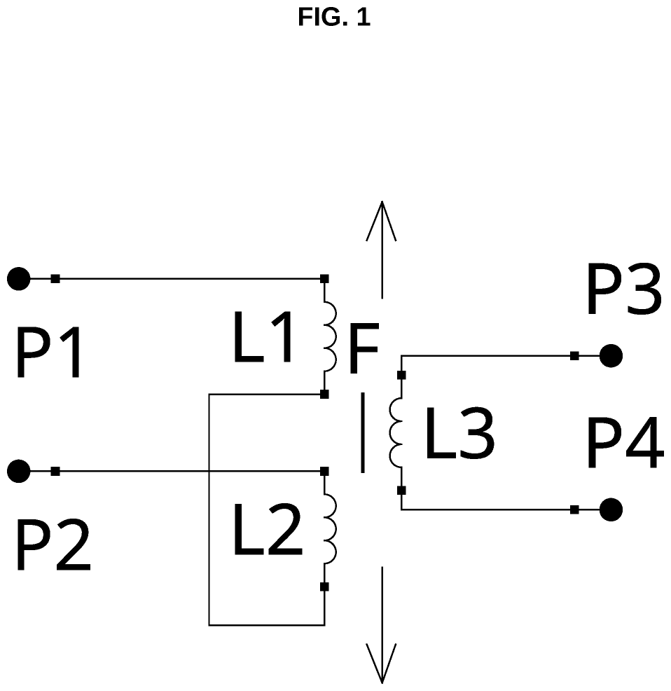

Theoretically, the conventional measurement of LVDT can be carried out with the usual audio card, by simply exciting P1 and P2 with an analog audio output channel (FIG. 1), and then reading the signal on P3 and P4 with a line or microphone input.

However, in practice this runs into numerous difficulties as the hardware and software was developed with human audio communication in mind, and not for making measurements. In particular, the following obstacles occur in real-world systems:
there might not be any way to synchronize output and input of digitized analog signals introducing variable delay between output of excitation signal and its recording. This makes analysis of input signal difficult and is an obstacle to determination whether L1 or L2 has more influence on the output signal as this results in change of the polarity of voltage on P3 and P4 terminals;
the amplitude of the output signal in volts might not be well-defined or impossible to determine by analysis software. For example, in many systems there are multiple volume controls over individual channels as well as a master control over output. In addition, even if the volume levels are fixed, there might be variation due to the internal voltage reference that was not designed for long-term stability;
the gain of the input channel and/or the recording volume can vary and in some systems (like Android phones) is inaccessible to software. In some systems there is an automatic gain control that varies gain without software knowledge;
many systems include additional circuitry to sense whether anything is connected to analog audio ports and change system configuration based on the readings;
many systems include additional circuitry to sense whether microphone is connected and sometimes provide voltage to power microphone amplifier.

To solve these issues we developed an adapter that allows LVDTs and similar devices to be used with commonly available tablets, phones, notebooks, microcontrollers and other computing devices.

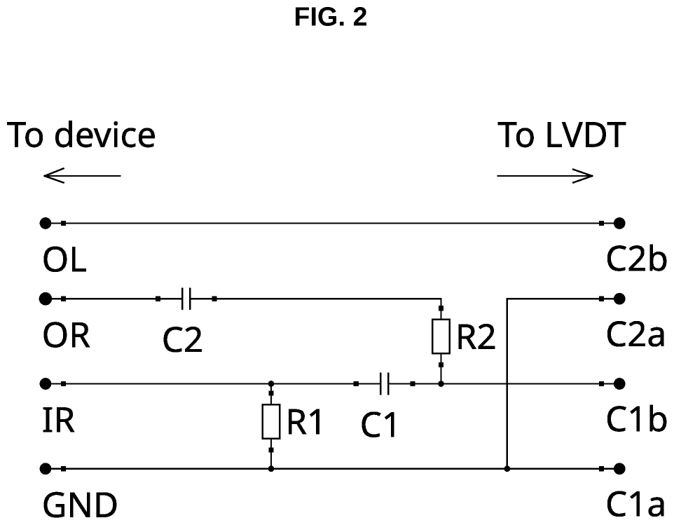

An example adapter schematic is shown on FIG. 2. On the left there are 4 terminals OL, OR, IR and GND to be connected to the left and right output channels, input channel and ground of the computing device. The left and right channels can be interchanged.

On the right, there are outputs to excitation coils of the LVDT (C2a and C2b) and the measurement coil (C1a and C1b). The excitation and measurement coils can be interchanged.

The optional capacitor C1 blocks any voltage coming from IR terminal from heating the LVDT coil. The resistor R1 is picked to signal to the computing device that the recording input is present. A value of 2.2 kOhm works well, but other values, including 0 Ohm are also suitable, depending on device specifications.

The capacitor C2 and resistor R2 allow to feed a signal from OR terminal directly to IR input. This allows probing of overall gain from output to input while bypassing LVDT. The capacitor C2 and resistor R2 can be interchanged, and even omitted when the gain is known or other coupling between output and input channel exists.

The signal fed to IR input also serves to provide a non-zero input when L3 and F are balanced, this can be used to stabilize automatic gain control and/or provide stable conditions for measurement.

If more output channels and/or input channels are available multiple LVDTs can be read out at the same time.

Additional output channels can drive coils L1 and L2 (FIG. 1) separately, in order to achieve specific balance of excitation. For example, the coils can be driven so as to keep the output signal from L3 smaller than a certain value.

When multiple input channels are available the scheme can be reversed by supplying signal to L3 and reading out L1 and L2.

When several input and output channels are available they can be utilized together to increase the sample rate and/or the number of sensors. For example, the sensors can be connected in such a way that no sensor utilizes identical input and output channels, so the selection of data from these channels allows to isolate the reading from the sensor.

A sensor with multiple coils or a connection of several sensors can be used to improve linearity of read out.

The acquisition and analysis of data is as important as electrical connections. The waveform shape can be adjusted dynamically during the operation. Multiple shapes and/or waveforms can be used to probe device state. Multiple shapes or waveforms can be selected depending on desired mode of operation or to signal a change of state.

When multiple synchronized output channels are available, such as in systems designed for stereo audio output, they can be driven with individual waveforms that allow to perform synchronous and/or differential measurements.

One or more output channels can be coupled to one or more input channels to provide a calibration signal. For example, for a signal from fixed coupling can be compared to a signal from LVDT, which is a variable coupling.

The coupling can be used to probe the overall gain from output to input channels. It is also very useful to compensate for drift of voltage reference in the data acquisition system, especially when a single voltage reference is used for both output and input channels.

These methods to readout LVDTs can also be applied to other devices which provide a variable coupling between two or more electrical paths. For example, one can use them with capacitive sensors and flux gate sensors.

1. An electrical circuit for making precision measurements with sensors interrogated by supplying an excitation voltages and/or currents and measuring the response as voltages and/or currents, comprising:
a driving circuit including a blocking capacitor to prevent dc currents from heating the sensor, an optional DC bypass to supply a small amount of current to power the sensors when needed and a shaping network to facilitate driving with acceptable voltage and/or currents and to minimize noise
a sampling circuit which adapts voltages and/or currents produced by the sensors for measurement
a probe circuit which diverts and adapts driving voltages and/or currents for measurement.

2. An electrical circuit in accordance with claim 1, further comprising a state reporting circuit which reports state of the electrical circuit and/or the sensor by a distinctive voltage and/or current and/or resistance.

3. An electrical circuit in accordance with claim 1, further comprising a state reporting circuit which reports state of the electrical circuit and/or the sensor by a distinctive voltage and/or current and/or resistance and includes a means of use control such as a switch or button.

4. An electrical circuit in accordance with claim 1, further comprising a shaping network that together with sensor forms a quasi-resonant circuit that improves measurement accuracy.

5. An electrical circuit in accordance with claim 1, further comprising a sampling circuit that together with sensor forms a quasi-resonant circuit that improves measurement accuracy.

6. An electrical circuit in accordance with claim 1, where two or more driving voltages and/or currents are used to balance excitation in such a way as to control the amplitude of voltages and/or currents produced by the sensors.

7. An electrical circuit in accordance with claim 1, further comprising a sampling circuit constructed in such a way as to produce voltage and/or currents similar to those produced by the sensors.

8. An electrical circuit in accordance with claim 1, further comprising a sampling circuit providing means of measuring temperature in one or more parts of the sensors and/or electrical circuit itself.

9. An electrical circuit in accordance with claim 1, further comprising a driving circuit including one or more components that provide an indication to the user such as by means of a visual display and/or sound.

10. An electrical circuit in accordance with claim 1, further comprising a driving circuit which resistance measures above 15 Ohms with the sensor attached.

11. An electrical circuit in accordance with claim 1, further comprising a sampling circuit which resistance measures above 15 Ohms with the sensor attached.

12. An electrical circuit in accordance with claim 1, further comprising a probe circuit which resistance measures above 15 Ohms with the sensor attached.
